(19) United States
(12) Patent Application Publication
(10) Pub. No.: US 2014/0243455 A1
(43) Pub. Date: Aug. 28, 2014

(54) P-PIPERAZINE COMPOUNDS AS FLAME RETARDANTS

(71) Applicant: BASF SE, Ludwigshafen (DE)

(72) Inventors: Rainer Xalter, Heidelberg (DE); Michael Roth, Lautertal (DE); Manfred Doering, Woerth (DE); Michael Ciesielski, Merseburg (DE); Sebastian Wagner, Ludwigshafen (DE)

(73) Assignee: BASF SE, Ludwigshafen (DE)

(21) Appl. No.: 14/352,147

(22) PCT Filed: Nov. 13, 2012
(86) PCT No.: PCT/EP12/72449

§ 371 Date: Apr. 16, 2014

Related U.S. Application Data
(60) Provisional application No. 61/559,731, filed on Nov. 15, 2011.

(30) Foreign Application Priority Data
Nov. 15, 2011 (EP) 11189087.7

(51) Int. Cl. C08K 5/5399

(52) U.S. Cl. CPC C08K 5/5399
USPC 523/452; 544/337

(57) ABSTRACT

The present invention relates to the use of aromatic P-piperazine-compounds in flame retardant polymer compositions. These compositions are especially useful for the manufacture of flame retardant compositions based on thermoplastic polymers, especially polyolefin homo- and copolymers, polycondensates, such as polyamines or polyesters and duroplastic polymers, such as polyepoxides.

The present invention relates to the use of aromatic P-piperazine-compounds in flame retardant polymer compositions. These compositions are especially useful for the manufacture of flame retardant compositions based on thermoplastic polymers, especially polyolefin homo- and copolymers, polycondensates, such as polyamines or polyesters and duroplastic polymers, such as polyepoxides.

Flame retardants are added to polymeric materials (synthetic or natural) to enhance the flame retardant properties of the polymers. Depending on their composition, flame retardants may act in the solid, liquid or gas phase either chemically, e.g. as a spumescent by liberation of nitrogen, and/or physically, e.g. by producing a foam coverage. Flame retardants interfere during a particular stage of the combustion process, e.g. during heating, decomposition, ignition or flame spread.

There is still a need for flame retardant compositions with improved properties that can be used in different polymer substrates. Increased standards with regard to safety and environmental requirements result in stricter regulations. Particularly known halogen containing flame retardants no longer match all necessary requirements. Therefore, halogen free flame retardants are preferred, particularly in view of their better performance in terms of smoke density associated with fire. Improved thermal stability and less corrosive behaviour are further benefits of halogen free flame retardant compositions.

Phosphaphenanthrene amides with trivalent phosphorus and thermoplastic polymer compositions are known from U.S. Pat. No. 4,380,515 as stabilizers for thermoplastics and elastomers to protect these substrates from degradation caused by the action of oxygen, light and heat.

Phosphaphenanthrene amides with trivalent phosphorus and their use in emulsions as photographic development accelerators are also known from EP 56 787.

It has surprisingly been found that thermoplastic or duroplastic polymers with excellent flame retardant properties are prepared in the event that aromatic P-piperazine-compounds are added to the polymer substrate.

These compositions have excellent thermal stability and are therefore especially suited for the application in engineering thermoplastics and epoxy laminates used for the manufacture of electrical and electronic parts and devices. Furthermore, epoxy resins comprising the inventive compounds show no or only a minor negative impact on the glass transition temperature, which is considered advantageous especially for their use in epoxy laminates for the manufacture of printed circuit boards. By using the instant flame retardant additives in thermoplastic and duroplastic resins, conventional halogen containing flame retardants and halogenated epoxy resins, antimony compounds, and inorganic fillers may largely be reduced or replaced.

The invention relates to the use of a P-piperazine-compound of the formula

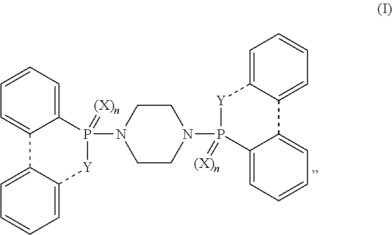

Wherein
   n represents zero or one;
   X represents oxygen or sulphur;

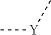

represents oxygen or a direct bond between phosphorus and the phenyl group;
the dotted line between the phenyl groups represents a direct bond adjacent to

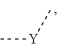

provided that

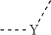

represents oxygen;
for inducing the flame retardancy in polymers.

The polymer compositions wherein the compounds (I), as defined above, are present, attain the desirable V-0 rating, according to UL-94 (Underwriter's Laboratories Subject 94) and other excellent ratings in related test methods, especially in glass fibre reinforced formulations where conventional FR systems tend to fail.

These compounds (I) and (IA) are preferably contained in the flame retardant compositions according to the invention in an amount from 1.0-90.0 wt. %, preferably 2.0-50.0 wt. %, based on the weight of the polymer substrate.

The term polymer and substrate comprises within its scope thermoplastic and duroplastic polymers and thermosets.

A list of suitable thermoplastic polymers is given below:
1. Polymers of monoolefins and diolefins, for example polypropylene, polyisobutylene, polybut-1-ene, poly-4-methylpent-1-ene, polyvinylcyclohexane, polyisoprene or polybutadiene, as well as polymers of cycloolefins, for instance of cyclopentene or norbornene, polyethylene (which optionally can be cross linked), for example high density polymethylene (HDPE), high density and high molecular weight polyethylene (HDPE-HMW), high density and ultrahigh molecular weight polyethylene (HDPE-UHMW), medium density polyethylene (MDPE), low density polyethylene (LDPE), linear low density polyethylene (LLDPE), (VLDPE) and (ULDPE).

Polyolefins, i.e. the polymers of monoolefins exemplified in the preceding paragraph, preferably polyethylene and polypropylene, can be prepared by different and especially by the following methods:
a) Radical polymerisation (normally under high pressure and at elevated temperature).
b) Catalytic polymerisation using a catalyst that normally contains one or more than one metal of groups IVb, Vb, VIb or VIII of the Periodic Table. These metals usually have one or more than one ligand, typically oxides, halides, alcoholates, esters, ethers, amines, alkyls, alkenyls and/or aryls that may be either α- or π-bond coordinated. These metal complexes may be in the free form or fixed on substrates, typically on activated magnesium chloride, titanium(III) chloride, alumina or silicon oxide. These catalysts may be soluble or insoluble in the polymerisation medium. The catalysts can be used by themselves in the polymerisation or further activators may be used, typically metal alkyls, metal hydrides, metal alkyl halides, metal alkyl oxides or metal alkyloxanes, said metals being elements of groups Ia, IIa and/or IIIa of the Periodic Table. The activators may be modified conveniently with further ester, ether, and amine or silyl ether groups. These catalyst systems are usually termed Phillips, Standard Oil Indiana, Ziegler-Natta), TNZ (DuPont), metallocene or single site catalysts (SSC).
2. Mixtures of the polymers mentioned under 1), for example mixtures of polypropylene with polyisobutylene, polypropylene with polyethylene (for example PP/HDPE, PP/LDPE) and mixtures of different types of polyethylene (for example LDPE/HDPE).
3. Copolymers of monoolefins and diolefins with each other or with other vinyl monomers, for example ethylene/propylene copolymers, linear low density polyethylene (LLDPE) and mixtures thereof with low density polyethylene (LDPE), propylene/but-1-ene copolymers, propylene/isobutylene copolymers, ethylene/but-1-ene copolymers, ethylene/hexene copolymers, ethylene/methylpentene copolymers, ethylene/heptene copolymers, ethylene/octene copolymers, ethylene/vinylcyclohexane copolymers, ethylene/cycloolefin copolymers (e.g. ethylene/norbornene like COC), ethylene/1-olefins copolymers, where the 1-olefin is generated in-situ; propylene/butadiene copolymers, isobutylene/isoprene copolymers, ethylene/vinylcyclohexene copolymers, ethylene/alkyl acrylate copolymers, ethylene/alkyl methacrylate copolymers, ethylene/vinyl acetate copolymers or ethylene/acrylic acid copolymers and their salts (ionomers) as well as terpolymers of ethylene with propylene and a diene such as hexadiene, dicyclopentadiene or ethylidene-norbornene; and mixtures of such copolymers with one another and with polymers mentioned in 1) above, for example polypropylene/ethylene-propylene copolymers, LDPE/ethylene-vinyl acetate copolymers (EVA), LDPE/ethylene-acrylic acid copolymers (EAA), LLDPE/EVA, LLDPE/EAA and alternating or random polyalkylene/carbon monoxide copolymers and mixtures thereof with other polymers, for example polyamides.
4. Hydrocarbon resins (for example C₅-C₉) including hydrogenated modifications thereof (e.g. tackifiers) and mixtures of polyalkylenes and starch;

The homopolymers and copolymers mentioned above may have a stereo structure including syndiotactic, isotactic, hemi-isotactic or atactic; where atactic polymers are preferred. Stereo block polymers are also included.
5. Polystyrene, poly(p-methylstyrene), poly(α-methylstyrene).
6. Aromatic homopolymers and copolymers derived from vinyl aromatic monomers including styrene, α-methylstyrene, all isomers of vinyl toluene, especially p-vinyl toluene, all isomers of ethyl styrene, propyl styrene, vinyl biphenyl, vinyl naphthalene, and vinyl anthracene, and mixtures thereof. Homopolymers and copolymers may have a stereo structure including syndiotactic, isotactic, hemi-isotactic or atactic; where atactic polymers are preferred. Stereo block polymers are also included;
   a) Copolymers including aforementioned vinyl aromatic monomers and comonomers selected from ethylene, propylene, dienes, nitriles, acids, maleic anhydrides, maleimides, vinyl acetate and vinyl chloride or acrylic derivatives and mixtures thereof, for example styrene/butadiene, styrene/acrylonitrile, styrene/ethylene (interpolymers), styrene/alkyl methacrylate, styrene/butadiene/alkyl acrylate, styrene/butadiene/alkyl methacrylate, styrene/maleic anhydride, styrene/acrylonitrile/methyl acrylate; mixtures of high impact strength of styrene copolymers and another polymer, for example a polyacrylate, a diene polymer or an ethylene/propylene/diene terpolymer; and block copolymers of styrene such as styrene/butadiene/styrene, styrene/isoprene/styrene, styrene/ethylene/butylene/styrene or styrene/ethylene/propylene/styrene.
   b) Hydrogenated aromatic polymers derived from hydrogenation of polymers mentioned under 6.), especially including polycyclohexylethylene (PCHE) prepared by hydrogenating atactic polystyrene, often referred to as polyvinylcyclohexane (PVCH).
   c) Hydrogenated aromatic polymers derived from hydrogenation of polymers mentioned under 6a). Homopolymers and copolymers may have a stereo structure including syndiotactic, isotactic, hemi-isotactic or atactic; where atactic polymers are preferred. Stereo block polymers are also included.
7. Graft copolymers of vinyl aromatic monomers, such as styrene or α-methylstyrene, for example styrene on polybutadiene, styrene on polybutadiene-styrene or polybutadiene-acrylonitrile copolymers; styrene and acrylonitrile (or methacrylonitrile) on polybutadiene; styrene, acrylonitrile and methyl methacrylate on polybutadiene; styrene and maleic anhydride on polybutadiene; styrene, acrylonitrile and maleic anhydride or maleimide on polybutadiene; styrene and maleimide on polybutadiene; styrene and alkyl acrylates or methacrylates on polybutadiene; styrene and acrylonitrile on ethylene/propylene/diene terpolymers; styrene and acrylonitrile on polyalkyl acrylates or polyalkyl methacrylates, styrene and acrylonitrile on acrylate/butadiene copolymers, as well as mixtures thereof with the copolymers listed under 6), for example the copolymer mixtures known as ABS, MBS, ASA or AES polymers.
8. Halogen-containing polymers such as polychloroprene, chlorinated rubbers, chlorinated and brominated copolymer of isobutylene-isoprene (halobutyl rubber), chlorinated or sulphochlorinated polyethylene, copolymers of ethylene and chlorinated ethylene, epichlorohydrin homo- and copolymers, especially polymers of halogen-containing vinyl compounds, for example polyvinyl chloride, polyvinylidene chloride, polyvinyl fluoride, polyvinylidene fluoride, as well as copolymers thereof such as vinyl chloride/vinylidene chloride, vinyl chloride/vinyl acetate or vinylidene chloride/vinyl acetate copolymers.
9. Polymers derived from α,β-unsaturated acids and derivatives thereof such as polyacrylates and polymethacrylates; polymethyl methacrylates, polyacrylamides and polyacrylonitriles, impact-modified with butyl acrylate.
10. Copolymers of the monomers mentioned under 9) with each other or with other unsaturated monomers, for example acrylonitrile/butadiene copolymers, acrylonitrite/alkyl acrylate copolymers, acrylonitrile/alkoxyalkyl acrylate or acrylonitrile/vinyl halide copolymers or acrylonitrile/alkyl methacrylate/butadiene terpolymers.
11. Polymers derived from unsaturated alcohols and amines or the acyl derivatives or acetals thereof, for example polyvinyl alcohol, polyvinyl acetate, polyvinyl stearate, polyvinyl benzoate, polyvinyl maleate, polyvinyl butyral, polyallyl phthalate or polyallyl melamine; as well as their copolymers with olefins mentioned in 1 above.
12. Homopolymers and copolymers of cyclic ethers such as polyalkylene glycols, polyethylene oxide, polypropylene oxide or copolymers thereof with bisglycidyl ethers.
13. Polyacetals such as polyoxymethylene and those polyoxymethylenes, which contain ethylene oxide as a co-monomer; polyacetals modified with thermoplastic polyurethanes, acrylates or MBS.
14. Polyphenylene oxides and sulphides, and mixtures of polyphenylene oxides with styrene polymers or polyamides.
15. Polyurethanes derived from hydroxyl-terminated polyethers, polyesters or polybutadienes on the one hand and aliphatic or aromatic polyisocyanates on the other, as well as precursors thereof.
16. Polyamides and co-polyamides derived from diamines and dicarboxylic acids and/or from aminocarboxylic acids or the corresponding lactams, for example polyamide 4, polyamide 6, polyamide 6/6, 6/10, 6/9, 6/12, 4/6, 12/12, polyamide 11, polyamide 12, aromatic polyamides starting from m-xylene diamine and adipic acid; polyamides prepared from hexamethylenediamine and isophthalic or/and terephthalic acid and with or without an elastomer as modifier, for example poly-2,4,4,-trimethylhexamethylene terephthalamide or poly-m-phenylene isophthalamide; and also block copolymers of the aforementioned polyamides with polyolefins, olefin copolymers, ionomers or chemically bonded or grafted elastomers; or with polyethers, e.g. with polyethylene glycol, polypropylene glycol or polytetramethylene glycol; as well as polyamides or co-polyamides modified with EPDM or ABS; and polyamides condensed during processing (RIM polyamide systems).
17. Polyureas, polyimides, polyamide imides, polyether imides, polyester imides, polyhydantoins and polybenzimidazoles.
18. Polyesters derived from dicarboxylic acids and diols and/or from hydroxycarboxylic acids or the corresponding lactones, for example polyethylene terephthalate, polybutylene terephthalate, poly-1,4-dimethylolcyclohexane terephthalate, polyalkylene naphthalate (PAN) and polyhydroxybenzoates, as well as block co-polyether esters derived from hydroxyl-terminated polyethers; and also polyesters modified with polycarbonates or MBS.
19. Polyketones.
20. Polysulphones, polyether sulphones and polyether ketones.
21. Blends of the aforementioned polymers (polyblends), for example PP/EPDM, Polyamide/EPDM or ABS, PVC/EVA, PVC/ABS, PVC/MBS, PC/ABS, PBTP/ABS, PC/ASA, PC/PBT, PVC/CPE, PVC/acrylates, POM/thermoplastic PUR, PC/thermoplastic PUR, POM/acrylate, POM/MBS, PPO/HIPS, PPO/PA 6.6 and copolymers, PA/HDPE, PA/PP, PA/PPO, PBT/PC/ABS or PBT/PET/PC.
22. Polycarbonates that correspond to the general formula:

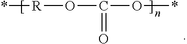

Such polycarbonates are obtainable by interfacial processes or by melt processes (catalytic transesterification). The polycarbonate may be either branched or linear in structure and may include any functional substituents. Polycarbonate copolymers and polycarbonate blends are also within the scope of the invention. The term polycarbonate should be interpreted as inclusive of copolymers and blends with other thermoplastics. Methods for the manufacture of polycarbonates are known, for example, from U.S. Pat. Nos. 3,030,331; 3,169,121; 4,130,458; 4,263,201; 4,286,083; 4,552,704; 5,210,268; and 5,606,007. A combination of two or more polycarbonates of different molecular weights may be used.

Preferred are polycarbonates obtainable by reaction of a diphenol, such as bisphenol A, with a carbonate source. Examples of suitable diphenols are:

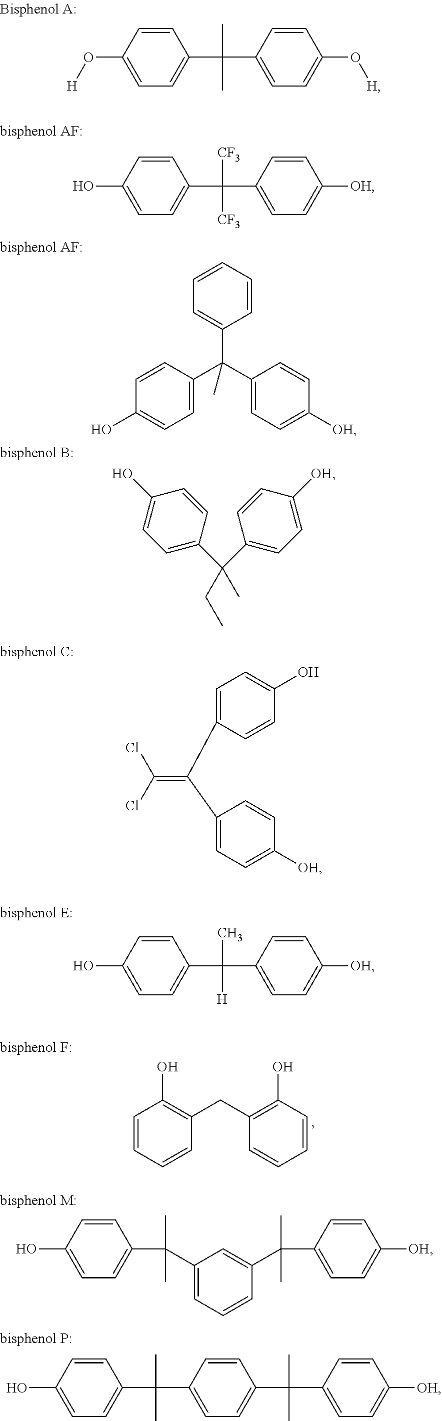

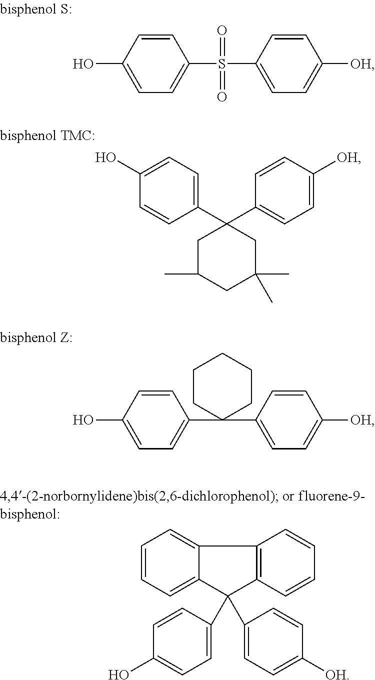 [SMILES: O=S(=O)(c1ccc(O)cc1)c1ccc(O)cc1 ; CC1CC(C)(C)CC(c2ccc(O)cc2)(c2ccc(O)cc2)C1 ; Oc1ccc(C2(c3ccc(O)cc3)CCCCC2)cc1 ; Oc1ccc(C2(c3ccc(O)cc3)c3ccccc3-c3ccccc32)cc1]

The carbonate source may be a carbonyl halide, a carbonate ester or a haloformate. Suitable carbonate halides are phosgene or carbonylbromide. Suitable carbonate esters are dialkylcarbonates, such as dimethyl- or diethylcarbonate, diphenyl carbonate, phenyl-alkylphenylcarbonate, such as phenyl-tolylcarbonate, dialkylcarbonates, such as dimethyl- or diethylcarbonate, di-(halophenyl)carbonates, such as di-(chlorophenyl)carbonate, di-(bromophenyl)carbonate, di-(trichlorophenyl)carbonate or di-(trichlorophenyl)carbonate, di-(alkylphenyl)carbonates, such as di-tolylcarbonate, naphthylcarbonate, dichloronaphthylcarbonate and others.

The polymer substrate mentioned above, which comprises polycarbonates or polycarbonate blends is a polycarbonate-copolymer, wherein isophthalate/terephthalate-resorcinol segments are present. Such polycarbonates are commercially available, e.g. Lexan® SLX (General Electrics Co. USA). Other polymeric substrates of component b) may additionally contain in the form as admixtures or as copolymers a wide variety of synthetic polymers including polyolefins, polystyrenes, polyesters, polyethers, polyamides, poly(meth)acrylates, thermoplastic polyurethanes, polysulphones, polyacetals and PVC, including suitable compatibilizing agents. For example, the polymer substrate may additionally contain thermoplastic polymers selected from the group of resins consisting of polyolefins, thermoplastic polyurethanes, styrene polymers and copolymers thereof. Specific embodiments include polypropylene (PP), polyethylene (PE), polyamide (PA), polybutylene terephthalate (PBT), polyethylene terephthalate (PET), glycol-modified polycyclohexylenemethylene terephthalate (PCTG), polysulphone (PSU), polymethylmethacrylate (PMMA), thermoplastic polyurethane (TPU), acrylonitrile-butadiene-styrene (ABS), acrylonitrilestyrene-acrylic ester (ASA), acrylonitrile-ethylene-propylene-styrene (AES), styrene-maleic anhydride (SMA) or high impact polystyrene (HIPS).

A preferred embodiment of the invention relates to the use of P—N-compounds (I) in thermoplastic polymers. Preferred thermoplastic polymers include polyamides, polyesters and polycarbonates.

Another preferred embodiment of the invention relates to composition, wherein component c) is a duroplastic polymer substrate of the polyepoxide type.

A preferred embodiment of the invention relates to a composition which comprises

a) A P-piperazine-compound of the formula

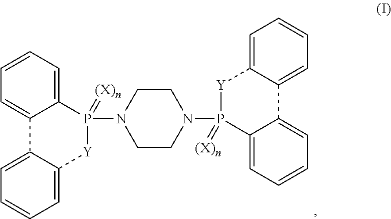

Wherein
n represents zero or one;
X represents oxygen or sulphur;

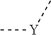

represents oxygen or a direct bond between phosphorus and the phenyl group;
the dotted line between the phenyl groups represents a direct bond adjacent to

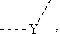

provided that

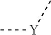

represents oxygen;

b) At least one polyfunctional epoxide compound; and, optionally,

c) A hardener compound.

A preferred embodiment relates to a composition, which comprises

a) A bis[9,10-dihydro-9-oxa-10-phosphaphenanthrene of the formula

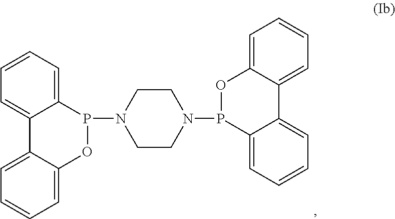 [SMILES: c1ccc2c(c1)OP(N1CCN(P3Oc4ccccc4-c4ccccc43)CC1)c1ccccc1-2]

b) At least one polyfunctional epoxide compound; and, optionally,

c) A hardener compound.

Suitable polyfunctional epoxide compounds are epoxides, wherein at least two epoxy groups of the partial formula

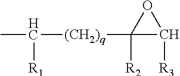

are present, which are attached directly to carbon, oxygen, nitrogen or sulphur atoms, and wherein q represents zero, R₁ and R₃ both represent hydrogen and R₂ represents hydrogen or methyl; or wherein q represents zero or 1, R₁ and R₃ together form the —CH₂—CH₂— or —CH₂—CH₂—CH₂— groups and R₂ represents hydrogen.

Suitable hardener components are, for example, amine and anhydride hardeners such as polyamines, e.g. ethylenediamine, diethylenetriamine, triethylenetriamine, hexamethylenediamine, methanediamine, N-aminoethyl piperazine, diaminodiphenylmethane [DDM], alkyl-substituted derivatives of DDM, isophoronediamine [IPD], diaminodiphenylsulphone [DDS], 4,4′-methylenedianiline [MDA], or m-phenylenediamine [MPDA]), polyamides, alkyl/alkenyl imidazoles, dicyandiamide [DICY], 1,6-hexamethylene-biscyanoguanidine, or acid anhydrides, e.g. dodecenylsuccinic acid anhydride, hexahydrophthalic acid anhydride, tetrahydrophthalic acid anhydride, phthalic acid anhydride, pyromellitic acid anhydride, and derivatives thereof.

A preferred embodiment of the invention relates to a composition which comprises

a) A bis[9,10-dihydro-9-oxa-10-phosphaphenanthrene]-piperazine of the formula

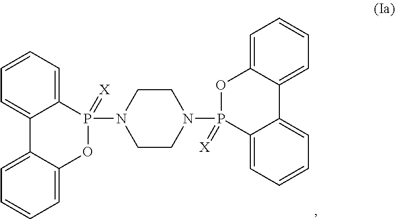

Wherein
X represents oxygen or sulphur; or

A compound of the formula

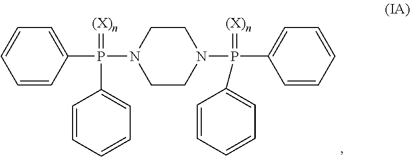

Wherein
n represents zero or one; and
X represents oxygen or sulphur; and

b) A polymer substrate.

The instant invention further pertains to the use of compounds (I) in flame retardant compositions which comprise, in addition to the components defined above, optional components, such as additional flame retardants and/or further additives selected from the group consisting of tetraalkylpiperidine additives, polymer stabilizers, fillers, reinforcing agents and so-called anti-dripping agents that reduce the melt flow of thermoplastic polymers and reduce the formation of drops at higher temperatures.

The invention also relates to a process for inducing the flame retardancy in polymers, which comprises adding to a polymer substrate a combination of at least one P-piperazine-compound of the formula

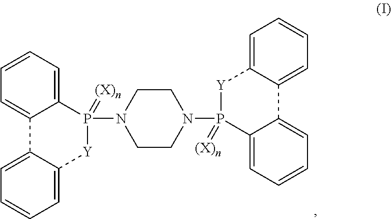

Wherein
   n represents zero or one;
   X represents oxygen or sulphur;

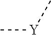

represents oxygen or a direct bond between phosphorus and the phenyl group;
the dotted line between the phenyl groups represents a direct bond adjacent to

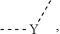

provided that

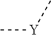

represents oxygen;
with at least one additional flame retardant.

Such additional flame retardants are phosphorus containing flame retardants, for example selected from the group consisting of phosphorus and/or nitrogen containing flame retardants, organohalogen containing flame retardants and inorganic flame retardants.

Phosphorus containing flame retardants are, for example, tetraphenyl resorcinol diphosphate, resorcinol phenylphosphate oligomer (Fyrolflex® RDP, Akzo Nobel), triphenyl phosphate, bisphenol A phenylphosphate oligomer (Fyrolflex® BDP), tris(2,4-di-tert-butylphenyl)phosphate, ethylenediamine diphosphate (EDAP), tetra(2,6-dimethylphenyl) resorcinol diphosphate, ammonium polyphosphate, diethyl-N,N-bis(2-hydroxyethyl)-aminomethyl phosphonate, hydroxyalkyl esters of phosphorus acids, salts of di-C₁-C₄alkylphosphinic acids and of hypophosphoric acid (H₃PO₂), particularly the Ca²⁺, Zn²⁺, or Al³⁺ salts, tetrakis(hydroxymethyl)phosphonium sulphide, triphenylphosphine, triphenyl phosphine oxide, tetraphenyldiphosphine monoxide, phosphazenes and 9,10-dihydro-9-oxa-10-phosphorylphenanthrene-10-oxide (DOPO) and its derivatives, such as 2-(9,10-dihydro-9-oxa-10-phosphaphenanthrene-10-oxide)-1,4-benzenediol.

Nitrogen generating flame retardants are, for example, isocyanurate flame retardants, such as polyisocyanurate, esters of isocyanuric acid or isocyanurates. Representative examples are hydroxyalkyl isocyanurates, such as tris-(2-hydroxyethyl)isocyanurate, tris(hydroxymethyl)isocyanurate, tris(3-hydroxy-n-proyl)isocyanurate or triglycidyl isocyanurate.

Nitrogen containing flame-retardants include further melamine-based flame-retardants. Representative examples are: melamine cyanurate, melamine borate, melamine phosphate, melamine pyrophosphate, melamine polyphosphate, melamine ammonium polyphosphate, melamine ammonium pyrophosphate, dimelamine phosphate and dimelamine pyrophosphate.

Further examples are: benzoguanamine, allantoin, glycoluril, urea cyanurate, ammonium polyphosphate, and a condensation product of melamine from the series melem, melam, melon and/or a higher condensed compound or a reaction product of melamine with phosphoric acid or a mixture thereof.

Representative organohalogen flame retardants are, for example:

Polybrominated diphenyl oxide (DE-60F, Great Lakes Corp.), decabromodiphenyl oxide (DBDPO; Saytex® 102E), tris[3-bromo-2,2-bis(bromomethyl)propyl]phosphate (PB 370®, FMC Corp.), tris(2,3-dibromopropyl)phosphate, tris(2,3-dichloropropyl)phosphate, chlorendic acid, tetrachlorophthalic acid, tetrabromophthalic acid, polychloroethyl triphosphonate mixture, tetrabromobisphenol A bis(2,3-dibromopropyl ether) (PE68), brominated epoxy resin, ethylene-bis(tetrabromophthalimide) (Saytex® BT-93), bis(hexachlorocyclopentadieno)cyclooctane (Declorane Plus®), chlorinated paraffins, octabromodiphenyl ether, 1,2-bis(tribromophenoxy)ethane (FF680), tetrabromo-bisphenol A (Saytex® RB100), ethylene bis-(dibromo-norbornanedicarboximide) (Saytex® BN-451), bis-(hexachlorocyclopentadieno) cyclooctane, PTFE, tris-(2,3-dibromopropyl)-isocyanurate, and ethylene-bis-tetrabromophthalimide.

The organohalogen flame retardants mentioned above are routinely combined with an inorganic oxide synergist. Most common for this use are zinc or antimony oxides, e.g. Sb₂O₃ or Sb₂O₅. Boron compounds are suitable, too.

Representative inorganic flame retardants include, for example, aluminium trihydroxide (ATH), boehmite (AlOOH), magnesium dihydroxide (MDH), hydrotalcite, zinc borates, CaCO₃, (organically modified) layered silicates, (organically modified) layered double hydroxides, and mixtures thereof.

Particularly preferred as additional flame retardant are nitrogen generating compounds selected from the group consisting of melamine cyanurate, melamine polyphosphate, ammonium polyphosphate, melamine ammonium phosphate, melamine ammonium polyphosphate, melamine ammonium pyrophosphate, a condensation product of melamine with phosphoric acid and other reaction products of melamine with phosphoric acid and mixtures thereof.

The above-mentioned additional flame retardant classes are advantageously contained in the composition of the invention in an amount from about 0.5% to about 40.0% by weight of the organic polymer substrate; for instance about 1.0% to about 30.0%; for example about 2.0% to about 25.0% by weight based on the total weight of the composition.

The combination of the P-piperazine-compound (I) and the additional flame retardant is preferably contained in the flame retardant compositions according to the process defined above in an amount from 0.5-60.0 wt. %, preferably 2.0-55.0 wt. %, based on the total weight of the composition.

According to another embodiment, the invention relates to compositions which additionally comprise as additional component so-called anti-dripping agents.

These anti-dripping agents reduce the melt flow of the thermoplastic polymer and inhibit the formation of drops at high temperatures. Various references, such as U.S. Pat. No. 4,263,201, describe the addition of anti-dripping agents to flame retardant compositions.

Suitable additives that inhibit the formation of drops at high temperatures include glass fibres, polytetrafluoroethylene (PTFE), high temperature elastomers, carbon fibres, glass spheres and the like.

The addition of polysiloxanes of different structures has been proposed in various references; cf. U.S. Pat. Nos. 6,660,787, 6,727,302 or 6,730,720.

According to a further embodiment, the invention relates to compositions which additionally comprise as additional components fillers and reinforcing agents. Suitable fillers are, for example, glass powder, glass microspheres, silica, mica and talcum.

Stabilizers are preferably halogen-free and selected from the group consisting of nitroxyl stabilizers, nitrone stabilizers, amine oxide stabilizers, benzofuranone stabilizers, phosphite and phosphonite stabilizers, quinone methide stabilizers and monoacrylate esters of 2,2′-alkylidenebisphenol stabilizers.

As mentioned above, the composition according to the invention may additionally contain one or more conventional additives, for example selected from pigments, dyes, plasticizers, antioxidants, thixotropic agents, levelling assistants, basic co-stabilizers, metal passivators, metal oxides, organophosphorus compounds, further light stabilizers and mixtures thereof, especially pigments, phenolic antioxidants, calcium stearate, zinc stearate, UV absorbers of the 2-hydroxy-benzophenone, 2-(2′-hydroxyphenyl)benzotriazole and/or 2-(2-hydroxyphenyl)-1,3,5-triazine groups.

Preferred additional additives for the compositions as defined above are processing stabilizers, such as the above-mentioned phosphites and phenolic antioxidants, and light stabilizers, such as benzotriazoles. Preferred specific antioxidants include octadecyl 3-(3,5-di-tert-butyl-4-hydroxyphenyl) propionate (IRGANOX 1076), pentaerythritoltetrakis[3-(3,5-di-tert-butyl-4-hydroxyphenyl)propionate] (IRGANOX 1010), tris(3,5-di-tert-butyl-4-hydroxyphenyl)isocyanurate (IRGANOX 3114), 1,3,5-trimethyl-2,4,6-tris(3,5-di-tert-butyl-4-hydroxybenzyl)benzene (IRGANOX 1330), triethyleneglycolbis[3-(3-tert-butyl-4-hydroxy-5-methylphenyl)propionate] (IRGANOX 245), and N,N′-hexane-1,6-diyl-bis[3-(3,5-di-tert-butyl-4-hydroxyphenyl)propionamide] (IRGANOX 1098). Specific processing stabilizers include tris(2,4-di-tert-butylphenyl)phosphite (IRGAFOS 168), 3,9-bis(2,4-di-tert-butylphenoxy)-2,4,8,10-tetraoxa-3,9-diphosphaspiro[5.5]undecane (IRGAFOS 126), 2,2′,2″-nitrilo[triethyl-tris(3,3′,5,5′-tetra-tert-butyl-1,1′-biphenyl-2,2′-diyl)]phosphite (IRGAFOS 12), and tetrakis(2,4-di-tert-butylphenyl)[1,1-biphenyl]-4,4′-diylbisphosphonite (IRGAFOS P-EPQ). Specific light stabilizers include 2-(2H-benzotriazole-2-yl)-4,6-bis(1-methyl-1-phenylethyl)phenol (TINUVIN 234), 2-(5-chloro(2H)-benzotriazole-2-yl)-4-(methyl)-6-(tert-butyl)phenol (TINUVIN 326), 2-(2H-benzotriazole-2-yl)-4-(1,1,3,3-tetramethylbutyl)phenol (TINUVIN 329), 2-(2H-benzotriazole-2-yl)-4-(tert-butyl)-6-(sec-butyl)phenol (TINUVIN 350), 2,2′-methylenebis(6-(2H-benzotriazol-2-yl)-4-(1,1,3,3-tetramethylbutyl)phenol) (TINUVIN 360), and 2-(4,6-diphenyl-1,3,5-triazin-2-yl)-5-[(hexyl)oxy]-phenol (TINUVIN 1577), 2-(2′-hydroxy-5′-methylphenyl)benzotriazole (TINUVIN P), 2-hydroxy-4-(octyloxy)benzophenone (CHIMASSORB 81), 1,3-bis-[(2′-cyano-3′,3′-diphenylacryloyl)oxy]-2,2-bis-{[(2′-cyano-3′,3′-diphenylacryloyl)oxy]methyl}-propane (UVINUL 3030, BASF), ethyl-2-cyano-3,3-diphenylacrylate (UVINUL 3035, BASF), and (2-ethylhexyl)-2-cyano-3,3-diphenylacrylate (UVINUL 3039, BASF).

According to a further embodiment the compositions comprise as an optional component the additional flame retardants defined above and additives selected from the group consisting of polymer stabilizers and tetraalkylpiperidine derivatives.

Representative examples of tetraalkylpiperidine derivatives are selected from the group consisting of
1-Cyclohexyloxy-2,2,6,6-tetramethyl-4-octadecylaminopiperidine,
bis(1-Octyloxy-2,2,6,6-tetramethylpiperidin-4-yl) sebacate,
2,4-bis[(1-Cyclohexyloxy-2,2,6,6-tetramethylpiperidin-4-yl)butylamino]-6-(2-hydroxyethylamino-s-triazine,
bis(1-Cyclohexyloxy-2,2,6,6-tetramethylpiperidin-4-yl) adipate,
2,4-bis[(1-Cyclohexyloxy-2,2,6,6-tetramethylpiperidin-4-yl)butylamino]-6-chloro-s-triazine,
1-(2-Hydroxy-2-methylpropoxy)-4-hydroxy-2,2,6,6-tetramethylpiperidine,
1-(2-Hydroxy-2-methylpropoxy)-4-oxo-2,2,6,6-tetramethylpiperidine,
1-(2-Hydroxy-2-methylpropoxy)-4-octadecanoyloxy-2,2,6,6-tetramethylpiperidine,
bis(1-(2-Hydroxy-2-methylpropoxy)-2,2,6,6-tetramethylpiperidin-4-yl) sebacate,
bis(1-(2-Hydroxy-2-methylpropoxy)-2,2,6,6-tetramethylpiperidin-4-yl) adipate,
2,4-bis{N-[(1-(2-Hydroxy-2-methylpropoxy)-2,2,6,6-tetramethylpiperidin-4-yl]-N-butylamino}-6-(2-hydroxyethylamino)-s-triazine,

The reaction product of 2,4-bis[(1-cyclohexyloxy-2,2,6,6-tetramethylpiperidin-4-yl)butylamino]-6-chloro-s-triazine with N,N′-bis(3-aminopropyl)ethylenediamine), 2,4-bis[(1-Cyclohexyloxy-2,2,6,6-tetramethylpiperidin-4-yl)butylamino]-6-(2-hydroxyethylamino)-s-triazine,

The oligomeric compound which is the condensation product of 4,4′-hexamethylenebis(amino-2,2,6,6-tetramethylpiperidine) and 2,4-dichloro-6-[(1-cyclohexyloxy-2,2,6,6-tetramethylpiperidin-4-yl)butylamino]-s-triazine end-capped with 2-chloro-4,6-bis(dibutylamino)-s-triazine,

The compound of the formula

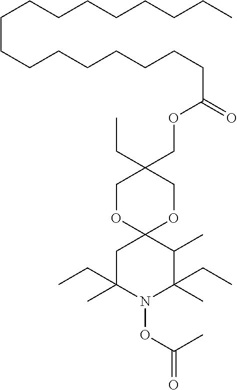 [SMILES: CCCCCCCCCCCCCCCCCC(=O)OCC1(CC)COC2(CC(C)(CC)N(OC(C)=O)C(C)(CC)C2C)OC1]

And the compound of the formula

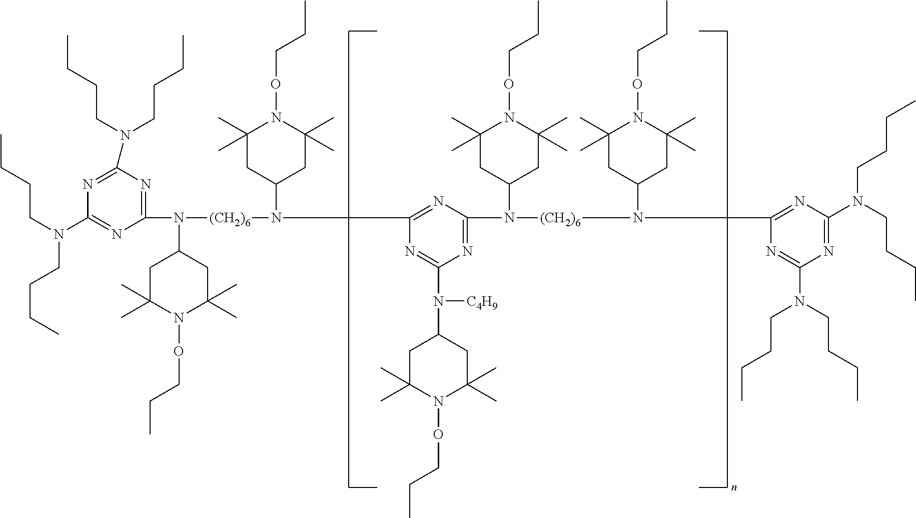

in which n is from 1 to 15.

The additives mentioned above are preferably contained in an amount of 0.01 to 10.0%, especially 0.05 to 5.0%, relative to the weight of the polymer substrate of Component c).

The incorporation of the components defined above into the polymer component is carried out by known methods such as dry blending in the form of a powder, or wet mixing in the form of solutions, dispersions or suspensions for example in an inert solvent, water or oil. The additive components may be incorporated, for example, before or after molding or also by applying the dissolved or dispersed additive or additive mixture to the polymer material, with or without subsequent evaporation of the solvent or the suspension/dispersion agent. They may be added directly into the processing apparatus (e.g. extruders, internal mixers, etc.), e.g. as a dry mixture or powder, or as a solution or dispersion or suspension or melt.

The addition of the additive components to the polymer substrate can be carried out in customary mixing machines in which the polymer is melted and mixed with the additives. Suitable machines are known to those skilled in the art. They are predominantly mixers, kneaders and extruders.

The process is preferably carried out in an extruder by introducing the additive during processing.

Particularly preferred processing machines are single-screw extruders, contra-rotating and co-rotating twin-screw extruders, planetary-gear extruders, ring extruders or cokneaders. Processing machines provided with at least one gas removal compartment can be used to which a vacuum can be applied.

Suitable extruders and kneaders are described, for example, in Handbuch der Kunststoffextrusion, Vol. 1 Grundlagen, Editors F. Hensen, W. Knappe, H. Potente, 1989, pp. 3-7, ISBN: 3-446-14339-4 (Vol. 2 Extrusionsanlagen 1986, ISBN 3-446-14329-7).

For example, the screw length is 1-60 screw diameters, preferably 35-48 screw diameters. The rotational speed of the screw is preferably 10-600 rotations per minute (rpm), preferably 25-300 rpm.

The maximum throughput is dependent on the screw diameter, the rotational speed and the driving force. The process of the present invention can also be carried out at a level lower than maximum throughput by varying the parameters mentioned or employing weighing machines delivering dosage amounts.

If a plurality of components is added, these can be premixed or added individually.

The additive components and optional further additives can also be added to the polymer in the form of a master batch (“concentrate”) which contains the components in a concentration of, for example, about 2.0% to about 80.0% and preferably 5.0% to about 50.0% by weight incorporated in a polymer. The polymer is not necessarily of identical structure than the polymer where the additives are added finally. In such operations, the polymer can be used in the form of powder, granules, solutions, and suspensions or in the form of lattices.

The additive components optional further additives can also be added to the polymer in the form of a master batch (“concentrate”) which contains the components in a concentration of, for example, about 1.0% to about 40.0% and preferably 2.0% to about 20.0% by weight incorporated in a polymer. The polymer is not necessarily of identical structure than the polymer where the additives are added finally. In such operations, the polymer can be used in the form of powder, granules, solutions, and suspensions or in the form of lattices.

Incorporation can take place prior to or during the shaping operation. The materials containing the additives of the invention described herein preferably are used for the production of molded articles, for example injection molded or roto-molded articles, injection molded articles, profiles and the like, and fibres, spun melt non-woven, films or foams.

A preferred embodiment of the invention relates to the process for inducing the flame retardancy in polymers, which comprises adding to the polymer substrate at least one bis[diphenylphosphino]piperazine of the formula

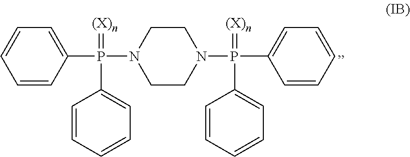

Wherein
   n represents zero or one; and
   X represents oxygen or sulphur.

The polymer substrate suitable for inducing flame retardancy has been described above.

The invention also relates to a bis[9,10-dihydro-9-oxa-10-phosphaphenanthrene]-piperazine of the formula

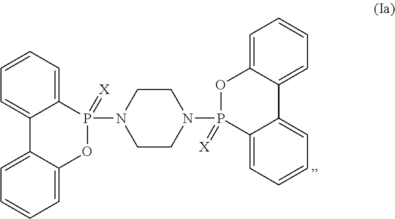

Wherein
X represents oxygen or sulphur.

The bis[9,10-dihydro-9-oxa-10-phosphaphenanthrene]-piperazine of the formula (Ia) defined above is obtainable by known methods, e.g. by subjecting a bis[9,10-dihydro-9-oxa-10-phosphaphenanthrene]-piperazine of the formula

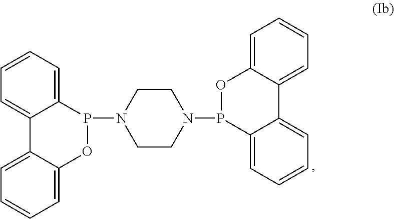 [SMILES: c1ccc2c(c1)OP(N1CCN(P3Oc4ccccc4-c4ccccc43)CC1)c1ccccc1-2]

to an oxidation reaction, or in-situ when incorporating into an organic polymer, for example by aerobic oxidation, or by extrusion in the presence of air or another oxidation agent, such as a peroxide or hydrogen peroxide.

This oxidation step is also subject matter of the present invention.

bis[9,10-Dihydro-9-oxa-10-phosphaphenanthrene]-piperazine of the formula Ib are obtainable by known methods, e.g. by reaction of 9,10-dihydro-9-oxa-10-phosphaphenanthrene-10-chloride with piperazine.

The starting material 9,10-dihydro-9-oxa-10-phosphaphenanthrene-10-chloride (DOP-CL) is obtainable by methods known in the literature, such as the ones described in EP 0 582 957.

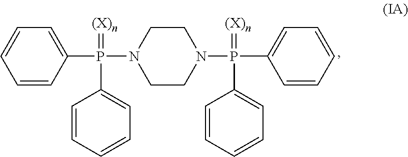

bis-Diphenylphosphinopiperazines (IB) defined above are obtainable by known methods, e.g. by subjecting a bis-diphenylphosphine-piperazine derivative of the formula

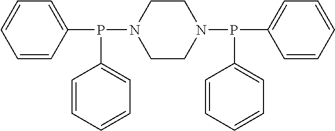 [SMILES: c1ccc(P(c2ccccc2)N2CCN(P(c3ccccc3)c3ccccc3)CC2)cc1]

to an oxidation reaction, or in-situ when incorporating into an organic polymer, for example by aerobic oxidation, or by extrusion in the presence of air or another oxidation agent, such as a peroxide or hydrogen peroxide.

This oxidation step is also subject matter of the present invention.

The following Examples illustrate the invention

### 1. PREPARATION OF

### 1.1 1,4-bis(6H-Dibenzo[c,e][1,2]oxaphosphinin-6-yl)-piperazine

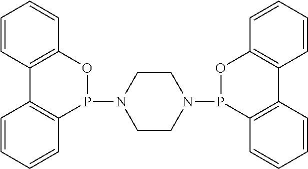 [SMILES: c1ccc2c(c1)OP(N1CCN(P3Oc4ccccc4-c4ccccc43)CC1)c1ccccc1-2]

A flame dried three neck flask flooded with argon is charged with DOP-CI (65.5 g, 279 mmol) and 100 ml dry chloroform. The addition funnel is charged with piperazine (12.0 g, 139 mmol) and 60 ml dry chloroform. The piperazine solution is slowly added to the reaction mixture. The reaction is allowed to heat up to 50° C. while a white precipitate is formed. When the addition is complete, the addition funnel is charged with triethylamine (30.6 g, 300 mmol) and 60 ml dry chloroform. The NEt₃ solution is slowly added to the reaction mixture without cooling. The reaction is again allowed to heat up to 50° C. When the addition is complete, the reaction is heated to 70° C. over night. After cooling to room temperature, the precipitate is filtered off and washed three times with water and acetone each. The product is obtained at a yield of 55.9 g (116 mmol, 83%) as a white powder having a melting point of 253° C.

³¹P NMR (101 MHz, CD₂Cl₂): δ 88.5 ppm (s).

¹H NMR (250 MHz, CD₂Cl₂): δ 7.93 (d, J=7.1 Hz, 2H), 7.83 (d, J=7.3 Hz, 2H), 7.54-7.32 (m, 8H), 7.16-7.11 (m, 2H), 7.04 (d, J=7.4 Hz, 2H), 2.48 ppm (s, 8H); IR (KBr): μm 3064 (w), 1582 (s), 1488 (vs), 1472, 1320, 1289, 1209, 1189 (s), 1151, 1115, 1042, 907 (s), 842, 797, 753, 668, 556, 419 cm⁻¹.

HR-MS (EI) calcd. for [¹²C₂₈H₂₄P₂N₂O₂]: 482.1313. found: 482.1306 [M]⁺.

### 1.2 6,6′-(Piperazine-1,4-diyl)-bis(6H-dibenzo[c,e][1,2]oxaphosphinine-6-oxide)

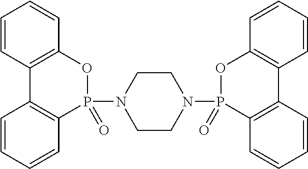 [SMILES: O=P1(N2CCN(P3(=O)Oc4ccccc4-c4ccccc43)CC2)Oc2ccccc2-c2ccccc21]

The product obtained according to Example 1.1 (3.38 g, 7.00 mmol) is stirred in ethyl acetate (50 ml) and cooled to 5° C. Hydrogen peroxide (10% in EtOAc, 5.00 g, 14.7 mmol) is added to the solution at this temperature. The product is filtered off and rinsed with acetone to yield 3.38 g (6.51 mmol, 93%) of a white powder having a melting point of 243° C.

³¹P NMR (101 MHz, CDCl₃): δ 15.7 ppm (s).

¹H NMR (250 MHz, CDCl₃): δ 8.00-7.93 (m, 4H), 7.88-7.79 (m, 3H), 7.69 (t, J=7.5 Hz, 2H), 7.51 (td, J=7.6 Hz, J=3.4 Hz, 4H), 7.41-7.35 (m, 3H), 3.20-3.24 ppm (m, 8H).

IR (KBr): μm 3062 (vw), 2902 (vw), 2968 (w), 1236 (vs), 1207 (vs), 1150, 1119 (s), 970 (vs), 909, 853, 761, 747, 704 cm⁻¹.

HR-MS (EI) calcd. for [¹²C₂₈H₂₄P₂N₂O₄]: 514.1211. found: 514.1291 [M]⁺.

EA [%] calcd. for ¹²C₂₈H₂₄P₂N₂O₄: C, 65.37; H, 4.70; N, 5.45. Found: C, 65.00; H, 4.79; N, 5.66.

### 1.3 6,6′-(Piperazine-1,4-diyl)-bis(6H-dibenzo[c,e][1,2]oxaphosphinine-6-sulphide)

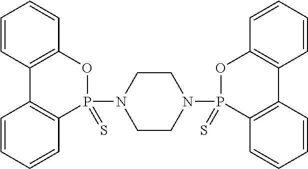 [SMILES: S=P1(N2CCN(P3(=S)Oc4ccccc4-c4ccccc43)CC2)Oc2ccccc2-c2ccccc21]

The product obtained according to Example 1.1 (3.11 g, 6.44 mmol) is stirred in toluene (40 ml) and heated to 50° C. Sulphur (413 mg, 12.9 mmol) is added at the same temperature. The reaction mixture is stirred at 110° C. for 1 h and cooled to room temperature. The product precipitates upon cooling and is filtered off to yield 2.66 g (4.87 mmol, 76%) of a powder having a melting point of 225° C.

³¹P NMR (101 MHz, CDCl₃): δ 73.3 ppm (s).

¹H NMR (250 MHz, CDCl₃): δ 7.90 (m, 4H), 7.80 (dd, J=15.3 Hz, J=7.4 Hz, 1H), 7.62 (t, J=7.5 Hz, 2H), 7.47 (td, J=7.2 Hz, J=2.8 Hz, 2H), 7.37 (t, J=7.6 Hz, 2H), 7.27-7.18 (m, 4H), 3.33-3.29 ppm (m, 8H).

IR (KBr): μm 3051 (w), 2950 (w), 2905 (w), 1474 (s), 1446, 1428, 1262, 1238, 1203, 1143, 1107 (vs), 1042, 966 (vs), 943, 911 (s), 785, 755, 720, 653, 616, 546 cm⁻¹.

HR-MS (EI) calcd. for [¹²C₂₈H₂₄P₂N₂O₂S₂]: 546.0754. found: 546.0737 [M]⁺.

EA [%] calcd. for ¹²C₂₈H₂₄P₂N₂O₂S₂: C, 61.53; H, 4.43; N, 5.13; S 11.73. Found: C, 61.36; H, 4.47; N, 5.11; S 11.40.

### 1.4 1,4-bis(Diphenylphosphino)piperazine

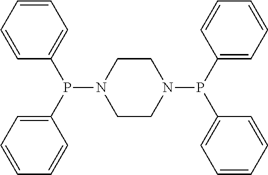 [SMILES: c1ccc(P(c2ccccc2)N2CCN(P(c3ccccc3)c3ccccc3)CC2)cc1]

A flame dried 500 ml three neck flask with an addition funnel, stirrer and condenser is charged with piperazine (19.5 g, 226 mmol), triethylamine (50.5 g, 498 mmol) and 300 ml dry chloroform. The reaction mixture is cooled to 5° C. The addition funnel is charged with chlorodiphenylphosphine (100 g, 453 mmol) diluted in 100 ml dry chloroform. This mixture is slowly added to the reaction mixture under vigorous stirring. The reaction temperature is not allowed to exceed 10° C. After completion, the reaction mixture is extracted three times with water to remove the triethylamine hydrochloride. The organic phases are combined, dried over sodium sulphate and the solvent is removed in vacuo to yield 98.4 g (216 mmol, 97%) of a white solid having a melting point of 135-140° C.

³¹P NMR (101 MHz, CDCl₃): δ 63.4 ppm (s). ¹H NMR (250 MHz, CDCl₃): δ 7.29-7.27 (m, 20H), 2.90-2.89 ppm (m, 8H).

IR (KBr): μm 3064 (w), 2950 (w), 2873 (w), 1636 (m), 1478 (s), 1127, 969 (vs), 546, 436 cm⁻¹.

HR-MS (EI) calcd. for [¹²C₂₈H₂₈P₂N₂]: 454.1728. found: 454.1664 [M]⁺.

### 1.5 Piperazine-1,4-diyl-bis(diphenylphosphine oxide)

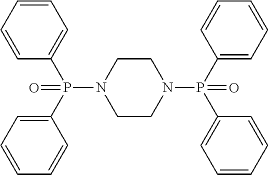 [SMILES: O=P(c1ccccc1)(c1ccccc1)N1CCN(P(=O)(c2ccccc2)c2ccccc2)CC1]

The product obtained from Example 1.4 (50.0 g, 110 mmol) is reacted with hydrogen peroxide (10% in ethyl acetate, 7.48 g, 220 mmol) according to the procedure described in Example 1.2 to yield 46.8 g (96.2 mmol, 87%) of a colourless solid having a melting point of 243-245° C.

³¹P NMR (101 MHz, CDCl₃): δ 35.0 ppm (s).

¹H NMR (250 MHz, CDCl₃): δ 7.87-7.80 (m, 8H), 7.45-7.41 (m, 12H), 3.10-3.08 ppm (m, 8H).

IR (KBr): μm 3059 (w), 2963 (w), 2914 (w), 1439 (vs), 1192 (vs), 1120, 952 (s), 721, 583, 552 cm⁻¹.

### 1.6 Piperazine-1,4-diyl-bis(diphenylphosphine sulphide)

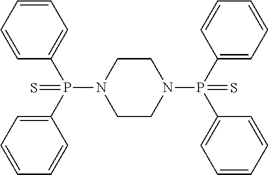 [SMILES: S=P(c1ccccc1)(c1ccccc1)N1CCN(P(=S)(c2ccccc2)c2ccccc2)CC1]

The product obtained from Example 1.4 (50.0 g, 110 mmol) is reacted with sulphur (7.05 g, 220 mmol) in 200 ml toluene according to the procedure described in Example 1.3. 46.7 g (90.1 mmol, 82%) of a white powder is obtained having a melting point of 269-270° C.

³¹P NMR (101 MHz, DMSO-d₆): δ 69.3 ppm (s).

¹H NMR (250 MHz, DMSO-d₆): δ 8.09-8.02 (m, 8H), 7.44-7.43 (m, 12H), 2.90 ppm (s, 8H).

IR (KBr): μm 3047 (w), 2963 (w), 2847 (w), 1437 (s), 953 (vs), 729 (vs), 643, 515 cm⁻¹.

HR-MS (EI) calcd. for [¹²C₂₈H₂₈P₂N₂S₂]: 518.1169. found: 518.1196 [M]⁺.

### 2. APPLICATION EXAMPLES

### 2.1 General Characterization Methods

The flammability of the test specimen is assessed according to UL 94 standards described in Flammability of Plastic Materials for Parts in Devices and Appliances, 5th edition, Oct. 29, 1996.

The thermal properties of laminates are determines by Differential Scanning Calorimetry (DSC) according to IPC-TM-650 2.4.25 for the determination of glass transition temperatures (T_{g}).

### 2.2 Cast Epoxy Resins

### 2.2.1 Materials and Methods

Phenol Novolak epoxy resin: DEN 438, Dow;
Dicyandiamide (DICY): Dyhard® 100S, AlzChem, Germany
Fenuron: DYHARD UR 300, AlzChem, Germany.
The desired amount of the flame retardant additive, 6 parts dicyandiamide and 2.0 parts Fenuron are combined with 100 parts of epoxy resin (DEN 438) at 90° C. and mixed in a high-speed dissolver DISPERMAT (VMA-Getzmann GmbH, Germany) at 6000 rpm under vacuum for 5 min. The formulation is transferred into an aluminium mold and cured at 110° C. for 1 hour, 130 C for 1 hour and postcured at 200° C. for 2 hours. All samples are allowed to cool down slowly to room temperature to avoid cracking.

### 2.2.2 Results

TABLE 1
UL94 V (4 mm) test results obtained with cast epoxy resins
based on DEN 438/DICY/Fenuron (results of 5 test specimen)

| FR-Additive | Loading | Total burning | UL94 | T_{g} |
|---|---|---|---|---|
| Example No. | [phr]¹⁾ | time [s] | Rating | [° C.] |
| Control | 0.00 | 517 | n.c.²⁾ | 181 |
| 1.1 | 9.12 | 107 | V-1 | 170 |
| 1.2 | 9.79 | 37 | V-0 | 178 |
| 1.2 | 15.37 | 39 | V-0 | 177 |
| 1.3 | 16.48 | 30 | V-0 | 183 |
| 1.4 | 8.55 | 77 | V-1 | 170 |
| 1.4 | 13.36 | 48 | V-0 | 170 |
| 1.5 | 9.21 | 119 | V-1 | 171 |
| 1.5 | 14.43 | 44 | V-0 | 171 |
| 1.6 | 9.87 | 92 | V-1 | 181 |
| 1.6 | 15.52 | 67 | V-1 | 179 |

¹⁾Parts per hundred resin
²⁾Not classified

### 2.2.3 Conclusion

The results presented above demonstrate that the inventive compounds and the inventive resin compositions exhibit flame retardant properties (UL94 V-1 and V-0 classification) at relatively low levels of additive loading. Resin compositions containing the inventive flame retardants exhibit high T_{g}-values which are close to or even exceeding the value obtained for the reference composition without flame retardant additive. It is desirable for many applications, especially for laminates being used for the manufacture of printed circuit boards, that the flame retardant additive has none or little negative influence on the T_{g} of the resin composition. Industrial practice has shown that variations <15° C. are acceptable for many applications.

### 2.3 Epoxy-Glass Cloth Laminates

### 2.3.1 Materials

o-Cresol Novolak epoxy resin: Araldite® ECN 1280, Huntsman Advanced Materials, Basel, Switzerland;
Hardeners: dicyanodiamide (DICY), Aldrich, Germany; Phenol Novolac (PN): Durite® SD 1702, Hexion, Switzerland;
Accelerator: 2-methylimidazole, Aldrich, Germany;
Solvents: 1-methoxy-2-propanol and dimethylformamide (DMF), both Merck Eurolab, Germany;
Glass cloth: Type 7628, P-D Interglas Technologies AG, Germany.

### 2.3.2 Methods

Epoxy Laminating/Hot Pressing Procedure for Araldite ECN 1280/DICY

A resin formulation is prepared by dissolving various quantities of ARALDITE ECN 1280 resin in 37.5 parts per hundred resin (phr) of methoxy-2-propanol at 95° C. 0.04 phr of 2-methylimidazole, the flame-retardant additives, as specified in Table 2, and 8.13 phr of DICY as a solution in a 1:1 mixture of 1-methoxy-2-propanol and DMF are added.

The formulation is hot coated onto a piece of glass cloth (Type 7628) and heated to 170 C for about 1.5-2 min in a forced draft oven. The fibre, now a non-tacky prepreg, is cut into seven strips (˜180×180 mm) which are stacked upon each other in a distance holder to assure the manufacture of laminates with uniform thicknesses of 1.6 mm. The strips are covered with two PTFE plates of 1 mm thickness on the upper and the lower side of the prepreg stack. The stack is placed on a hot press, and the stacked prepregs are subjected to a pressure of 3 bar at 170° C. for a period of 2 h.

The resulting laminate is removed from the hot press, cooled to ambient temperature under 3 bar pressure, and separated from the distance holder and PTFE plates. The laminate is cut to a piece of ˜150×150 mm by cutting off the edges with varying amounts of resin, weighed, its thickness measured, and its percent resin content determined. Test bars of the required dimensions are obtained by water jet cutting of the laminates.

### 2.3.3 Epoxy Laminating/Hot Pressing Procedure for Araldite ECN 1280/Phenol Novolac (PN)

Stock formulations of Araldite® ECN 1280 (85 wt.-%) and PN (50 wt.-%) in 1-methoxy-2-propanol are prepared. To obtain the desired resin formulations, the appropriate quantity of the stock solution of ECN 1280 is mixed with 44.4 phr of the PN stock solution at 60° C. for 30 min. Additional 1-methoxy-2-propanol is added if necessary to adjust the viscosity of the formulation. 0.10 phr 2-Methylimidazole and the flame-retardant additives as specified in Table 3 are added and homogenized with the resin solution.

The formulation is hot coated onto a piece of glass cloth (type 7628) and heated to 170° C. for about 1.5-2 min in a forced draft oven. The fibre, now a non-tacky prepreg, is cut into seven strips (˜180×180 mm) which are stacked upon each other in a distance holder to assure the manufacture of laminates with uniform thicknesses of 1.6 mm. The strips are covered with two PTFE plates of 1 mm thickness on the upper and the lower side of the prepreg stack. The stack is placed on a hot press, and the stacked prepregs are subjected to a pressure of 3 bar at 190 C for a period of 4 h.

The resulting laminate is removed from the hot press, cooled to ambient temperature under 3 bar pressure, and separated from the distance holder and PTFE plates. The laminate is cut to a piece of ˜150×150 mm by cutting off the edges with varying amounts of resin, weighed, its thickness measured, and its percent resin content determined. Test bars of the required dimensions are obtained by water jet cutting of the laminates.

### 2.3.4 Results

TABLE 2
UL94 V (1.6 mm) test results obtained with epoxy laminates based
on ARALDITE ECN 1280/DICY (results of 5 test specimen)

| | FR- | Resin content | | UL94- |
|---|---|---|---|---|
| Example | Additive(s) | of laminate | Total burning | Rating (1.6 |
| No. | [phr]¹⁾ | [wt.-%] | time [s] | mm) |
| Control | — | 37.4 | 215 | n.c.²⁾ |
| 1.1 | 23.2 | 43.1 | 54 | V-1 |
| 1.2 | 25.4 | 43.5 | 39 | V-0 |
| 1.3 | 27.4 | 41.0 | 110 | V-1 |
| 1.4 | 21.9 | 46.8 | 54 | V-1 |
| 1.5 | 23.8 | 37.8 | 103 | V-1 |
| 1.6 | 25.8 | 40.2 | 89 | V-1 |

¹⁾Parts per hundred resin
²⁾Not classified

TABLE 3
UL94 V (1.6 mm) test results obtained with
epoxy laminates based on ARALDITE ECN 1280/Durite
SD 1702 (results of 5 test specimen)

| | FR | Resin content | | UL94- |
|---|---|---|---|---|
| | Additive(s) | of laminate | Total burning | Rating (1.6 |
| Example | [phr] | [wt.-%] | time [s] | mm) |
| Control | — | 42.3 | 321 | n.c. |
| 1.1 | 34.9 | 40.6 | 115 | V-1 |
| 1.2 | 37.5 | 37.9 | 107 | V-1 |
| 1.3 | 40.5 | 39.8 | 117 | V-1 |
| 1.5 | 35.3 | 33.8 | 80 | V-1 |
| 1.6 | 38.2 | 40.6 | 137 | V-1 |

¹⁾ Parts per hundred resin
²⁾ Not classified

### 2.3.5 Conclusion

The results presented above demonstrate that the inventive compounds and the inventive resin compositions exhibit flame retardant properties (UL94 V-1 and V-0 classification). Resin compositions containing the inventive flame retardants, either alone or in combination with other flame retardants, give laminates with good laminate properties and excellent flame retardancy at relatively low levels of additives loading.

1. Use of a P-piperazine-compound of the formula 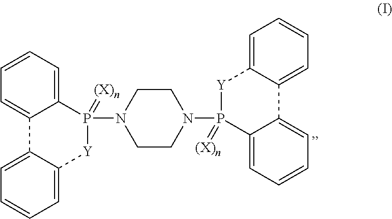
Wherein
n represents zero or one;
X represents oxygen or sulphur; 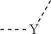
represents oxygen or a direct bond between phosphorus and the phenyl group;
the dotted line between the phenyl groups represents a direct bond adjacent to 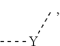
provided that 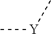
represents oxygen;
for inducing the flame retardancy in polymers.

2. A process for inducing the flame retardancy in polymers, which comprises adding to a polymer substrate a combination of at least one P—N-compound of the formula 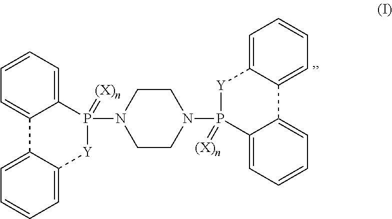
Wherein
n represents zero or one;
X represents oxygen or sulphur; 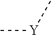
represents oxygen or a direct bond between phosphorus and the phenyl group;
the dotted line between the phenyl groups represents a direct bond adjacent to 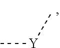
provided that 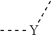
represents oxygen;
with at least one additional flame retardant.

3. A process according to claim 2 for inducing the flame retardancy in polymers, which comprises adding to the polymer substrate at least one bis[diphenylphosphino]piperazine of the formula 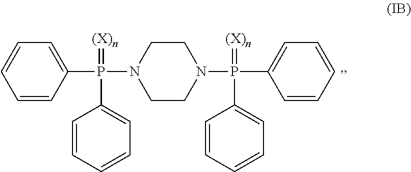
Wherein
n represents zero or one; and
X represents oxygen or sulphur.

4. A bis[9,10-dihydro-9-oxa-10-phosphaphenanthrene]-piperazine of the formula 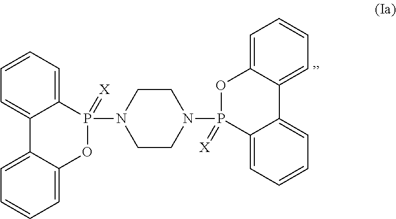
Wherein
X represents oxygen or sulphur.

5. A composition which comprises
a) A P-piperazine-compound of the formula 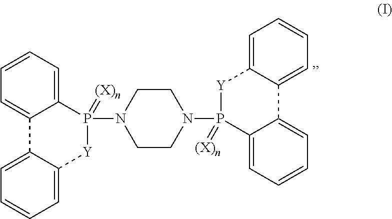
Wherein
n represents zero or one;
X represents oxygen or sulphur; 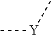
represents oxygen or a direct bond between phosphorus and the phenyl group;
the dotted line between the phenyl groups represents a direct bond adjacent to 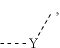
provided that 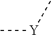
represents oxygen;
b) At least one polyfunctional epoxide compound; and, optionally,
c) A hardener compound.

6. A composition according to claim 5, which comprises
a) A bis[9,10-dihydro-9-oxa-10-phosphaphenanthrene of the formula 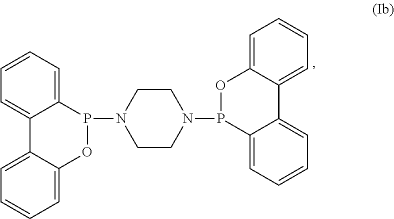 [SMILES: c1ccc2c(c1)OP(N1CCN(P3Oc4ccccc4-c4ccccc43)CC1)c1ccccc1-2]
b) At least one polyfunctional epoxide compound; and, optionally
c) A hardener compound.

7. A composition which comprises
a) A bis[9,10-dihydro-9-oxa-10-phosphaphenanthrene]-piperazine of the formula 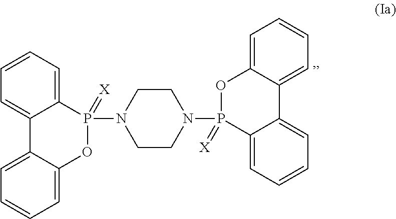
Wherein
X represents oxygen or sulphur; or
A compound of the formula 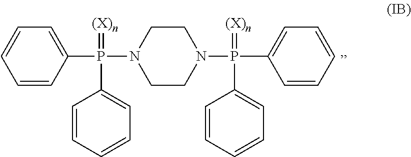
Wherein
n represents zero or one; and
X represents oxygen or sulphur; and
b) A polymer substrate.

8. A composition according to claim 7, which comprises as an optional component additional flame retardants and additives selected from the group consisting of tetraalkylpiperidine additives, polymer stabilizers, fillers, reinforcing agents and so-called anti-dripping agents that reduce the melt flow of thermoplastic polymers and reduce the formation of drops at higher temperatures.

9. A composition according to claim 8, which comprises as an additional flame retardant a nitrogen containing compound selected from the group consisting of melamine polyphosphate, ammonium polyphosphate, melamine ammonium phosphate, melamine ammonium polyphosphate, melamine ammonium pyrophosphate, a condensation product of melamine with phosphoric acid and other reaction products of melamine with phosphoric acid and mixtures thereof.

10. A composition according to claim 8, which comprises as an additional flame retardant a phosphorus containing flame retardant selected from the group consisting of tetra(2,6-dimethylphenyl)resorcinol diphosphate, salts of di-C₁-C₄alkylphosphinic acid, salts of hypophosphoric acid and 9,10-dihydro-9-oxa-10-phosphorylphenanthrene-10-oxide (DOPO) and its derivatives.

11. A composition according to claim 8, which additionally comprises at least one tetraalkylpiperidine derivative selected from the group consisting of
1-Cyclohexyloxy-2,2,6,6-tetramethyl-4-octadecylaminopiperidine,
bis(1-Octyloxy-2,2,6,6-tetramethylpiperidin-4-yl) sebacate,
2,4-bis[(1-Cyclohexyloxy-2,2,6,6-tetramethylpiperidin-4-yl)butylamino]-6-(2-hydroxyethylamino-s-triazine,
bis(1-Cyclohexyloxy-2,2,6,6-tetramethylpiperidin-4-yl) adipate,
2,4-bis[(1-Cyclohexyloxy-2,2,6,6-tetramethylpiperidin-4-yl)butylamino]-6-chloro-s-triazine,
1-(2-Hydroxy-2-methylpropoxy)-4-hydroxy-2,2,6,6-tetramethylpiperidine,
1-(2-Hydroxy-2-methylpropoxy)-4-oxo-2,2,6,6-tetramethylpiperidine,
1-(2-Hydroxy-2-methylpropoxy)-4-octadecanoyloxy-2,2,6,6-tetramethylpiperidine,
bis(1-(2-Hydroxy-2-methylpropoxy)-2,2,6,6-tetramethylpiperidin-4-yl) sebacate,
bis(1-(2-Hydroxy-2-methylpropoxy)-2,2,6,6-tetramethylpiperidin-4-yl) adipate,
2,4-bis{N-[1-(2-Hydroxy-2-methylpropoxy)-2,2,6,6-tetramethylpiperidin-4-yl]-N-butylamino}-6-(2-hydroxyethylamino)-s-triazine,
The reaction product of 2,4-bis[(1-cyclohexyloxy-2,2,6,6-tetramethylpiperidin-4-yl)butylamino]-6-chloro-s-triazine with N,N′-bis(3-aminopropyl)ethylenediamine),
2,4-bis[(1-Cyclohexyloxy-2,2,6,6-tetramethylpiperidin-4-yl)butylamino]-6-(2-hydroxyethylamino)-s-triazine,
The oligomeric compound which is the condensation product of 4,4′-hexamethylenebis(amino-2,2,6,6-tetramethylpiperidine) and 2,4-dichloro-6-[(1-cyclohexyloxy-2,2,6,6-tetramethylpiperidin-4-yl)butylamino]-s-triazine end-capped with 2-chloro-4,6-bis(dibutylamino)-s-triazine,
The compound of the formula 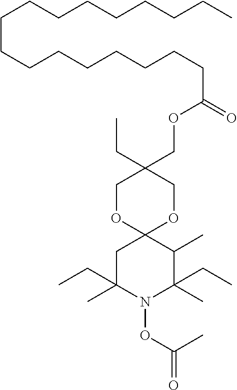 [SMILES: CCCCCCCCCCCCCCCCCC(=O)OCC1(CC)COC2(CC(C)(CC)N(OC(C)=O)C(C)(CC)C2C)OC1]
And the compound of the formula 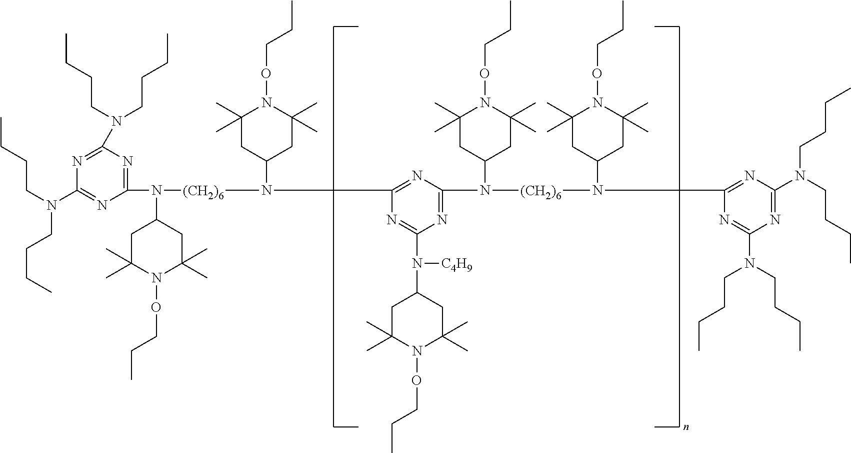
in which n is from 1 to 15.
